(19) United States
(12) Patent Application Publication
(10) Pub. No.: US 2020/0019916 A1
(43) Pub. Date: Jan. 16, 2020

(54) ATTENDANCE MANAGEMENT SYSTEM

(71) Applicant: Absentee Management LLC, Whitmore Lake, MI (US)

(72) Inventor: Malcolm Parrish, Detroit, MI (US)

(73) Assignee: Absentee Management LLC, Whitmore Lake, MI (US)

(21) Appl. No.: 16/193,233

(22) Filed: Nov. 16, 2018

Related U.S. Application Data
(60) Provisional application No. 62/697,958, filed on Jul. 13, 2018.

(51) Int. Cl. G06Q 10/06; G06Q 10/10; H04W 4/029

(52) U.S. Cl. CPC G06Q 10/063114; H04W 4/029; G06Q 10/10

(57) ABSTRACT

The technology described herein relates to a system and method for improving employee absenteeism, and in particular, to coordinating and optimizing a series of attendance assistance processes. The method includes analyzing a plurality of attendance assistance request inputs by attendance management processing servers, the analyzing based on at least on a relative geographical position of an employee computing device to available attendance assistance options to first determine best available employee attendance assistance options, and based on the attendance assistance request inputs and further on the attendance management processing servers optimization of best attendance assistance solutions, directing an employee to various employee attendance assistance options to include specific solution information including at least graphical mapping of the specific solutions, the specific solutions including any of: transportation assistance, child care assistance, pet care assistance or medical assistance until the absence status is converted to an attend status.

### CROSS REFERENCE TO RELATED PATENTS/PATENT APPLICATIONS

The present U.S. Utility Patent Application claims priority pursuant to 35 U.S.C. § 119(e) to U.S. Provisional Application No. 62/697,958, entitled “ATTENDANCE MANAGEMENT SYSTEM,” filed Jul. 13, 2018, which is hereby incorporated herein by reference in its entirety and made part of the present U.S. Utility Patent Application for all purposes.

### BACKGROUND

### Technical Field

The technology described herein relates generally to a system and method for improving employee absenteeism, and in particular, to a system and method for implementing a series of attendance improvement processes.

### Description of Related Art

Some efforts have been made to automate matching riders to vehicles for various rideshare programs. However, these systems are transport centric without analyzing how this rider integrates into an employer's overall attendance system or how other similar employee assistance measures can be implemented using analytics for various consumer and commercial use cases related to absenteeism.

### BRIEF DESCRIPTION OF THE DRAWINGS

FIG. 1 illustrates one embodiment of a system architecture in accordance with the present disclosure;

FIG. 2 illustrates a flowchart representing a process for accurately guiding an employee to capture attendance data and option selections in accordance with the present disclosure;

FIG. 3 illustrates one embodiment of a system architecture in accordance with the present disclosure;

FIG. 4 illustrates a diagram of transforming a possible employee absence into a confirmed attendance through employee transport options in accordance with the present disclosure;

FIG. 5 illustrates an example of screen images for an employee check-in in accordance with the present disclosure;

FIG. 6 illustrates an example of screen images for employee transport options in accordance with the present disclosure;

FIG. 7 illustrates an example of screen images for rideshare options in accordance with the present disclosure;

FIG. 8 illustrates an example of screen images for potential pick-up options in accordance with the present disclosure;

FIG. 9 illustrates an example of screen images for system reporting in accordance with the present disclosure; and

FIG. 10 illustrates a diagram of transforming a possible employee absence into a confirmed attendance through various employee absence assistance solutions in accordance with the present disclosure.

### DETAILED DESCRIPTION

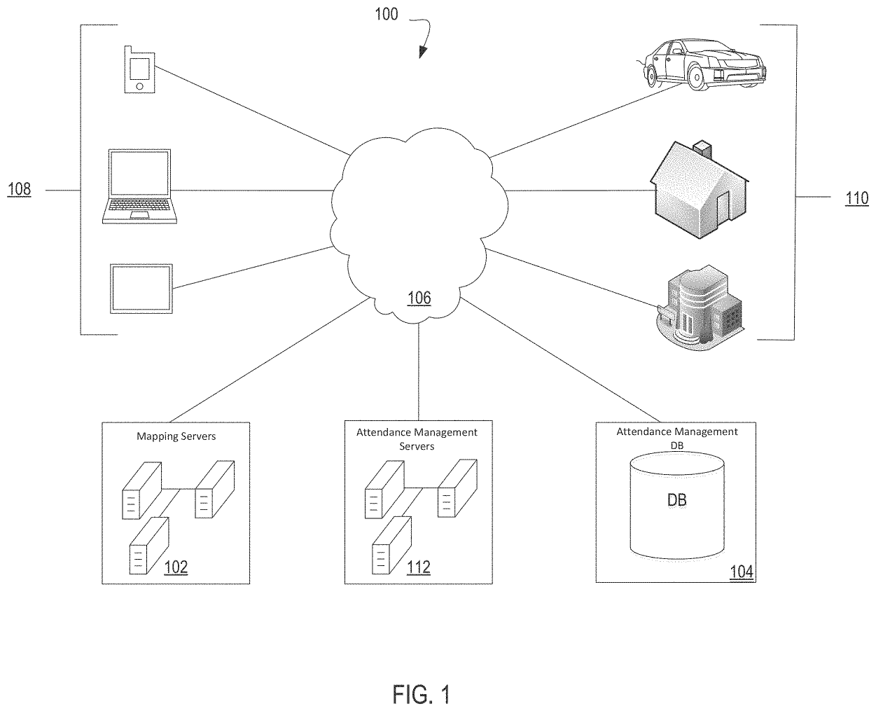

FIG. 1 illustrates one embodiment of a system architecture for an attendance management system in accordance with the present disclosure. In one embodiment, attendance management processing system 100 includes mapping servers 102, attendance management database (DB) 104, and attendance management servers 112 coupled via a network channel 106.

Network channel 106 is a system for communication. Network channel 106 includes, for example, an Ethernet or other wire-based network or a wireless NIC (WNIC) or wireless adapter for communicating with a wireless network, such as a WI-FI network. In other embodiments, network channel 106 includes any suitable network for any suitable communication interface. As an example, and not by way of limitation, the network channel 106 can include an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As another example, network channel 106 can be a wireless PAN (WPAN) (such as, for example, a BLUETOOTH WPAN), a WI-FI network, a WI-MAX network, a 3G, 4G, 5G network, LTE, a cellular telephone network (such as, for example, a Global System for Mobile Communications (GSM) network).

In one embodiment, network channel 106 uses standard communications technologies and/or protocols. Thus, network channel 106 can include links using technologies such as Ethernet, 802.11, worldwide interoperability for microwave access (WiMAX), 3G, 4G, LTE, CDMA, digital subscriber line (DSL), etc. Similarly, the networking protocols used on network channel 106 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). In one embodiment, the data exchanged over network channel 106 is represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec). Network channel 106 may include a cloud computing environment according to various embodiments of the present invention. A cloud computing environment includes one or more cloud computing nodes with which local computing devices used by cloud consumers, such as, for example, user (employee) devices 108 may communicate. Nodes may also communicate with one another. They may be grouped (not shown) physically or virtually, in one or more networks, such as Private, Community, Public, or Hybrid clouds, or a combination thereof. This allows cloud computing environment to offer infrastructure, platforms and/or software as services for which a cloud consumer does not need to maintain resources on a local computing device.

In one or more embodiments, user devices 108 are in communication with attendance management servers 112 for collecting attendance, commuting and other assistance data for employees. User devices 108 are defined as electronic devices for capturing data inputs. For example, the user devices include, but are not limited to: a phone, a smartphone, a tablet, a computer, a laptop, wearable computing devices, sensors, equivalents or any combination thereof. In addition, visual and/auditory responses are provided back to the user devices 108 to guide an employee through various attendance choices, inputs and system and supervisory feedback. In one or more embodiments, user devices 108 include a viewer device that is defined as a display device. For example, a viewer device can be a screen of smartphone, a computer with a monitor, a laptop, a touch screen display, an LED array, a television set, a projector display, a wearable heads-up display of some sort, or any combination thereof. In one or more embodiments, the viewer device includes display of one or more reports, specific employee data, trends, charts, expenses and associated measurements/calculations. The user devices 108 also include user input capabilities, such as, for example, a conventional desktop personal computer having input devices such as a mouse, keyboard, joystick, or other such input devices enabling the input of data and interaction with the displayed images and application screens, associated maps, calculations, employer related communications (e.g., texts, calls, email, alerts, notifications, etc.).

In one or more embodiments, mapping servers 102 include suitable hardware/software in the form of circuitry, logic gates, and/or code functions to process employee assistance data to include, but not limited to, available transportation information, available child care information or available health services (collectively illustrated as element 110). Mapping servers 102 provide visual maps to user devices indicating a relative position of the employee to various available attendance related services.

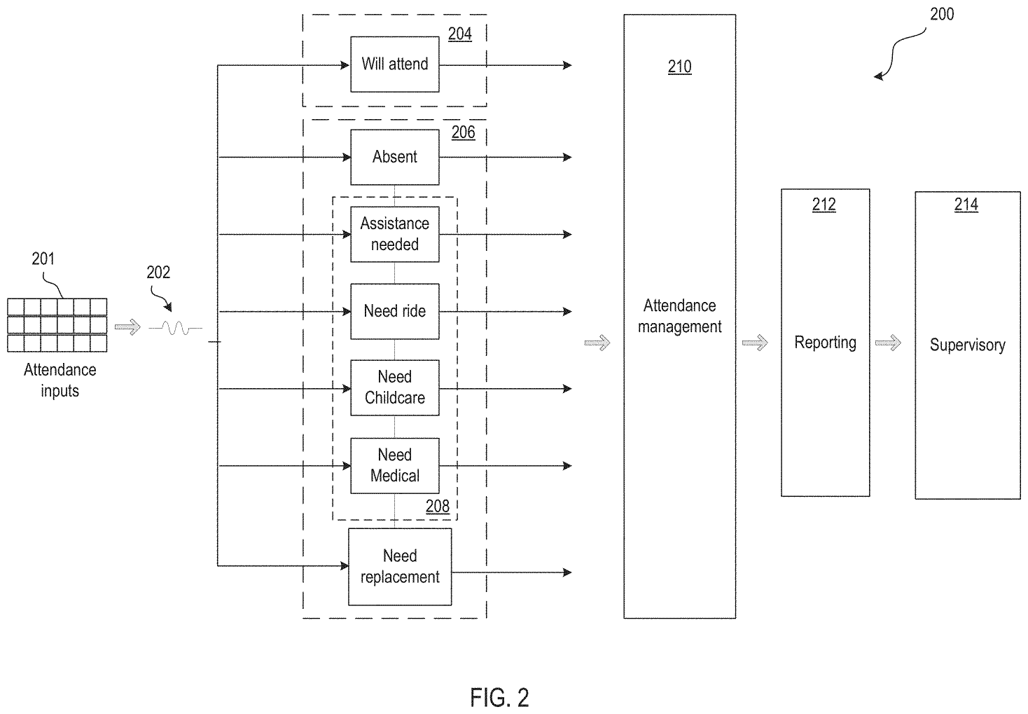

FIG. 2 illustrates a flowchart representing a process for guiding an employee of a computing device 108 (e.g., smartphone) to provide potential future attendance data responses, requests and/or other communications. Attendance management data will be uploaded to attendance management processing servers 102 to be instantiated as various displayable attendance screenshots (e.g., input screens, maps, directions, schedules, reports, etc.).

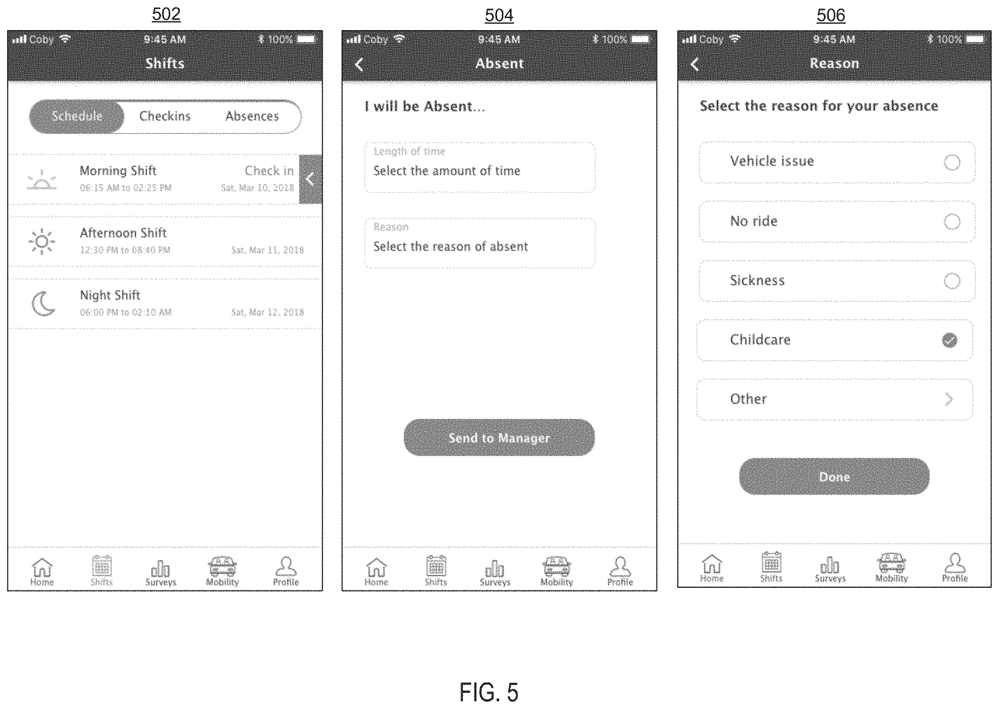

Process 200 begins in step 201 by receiving attendance inputs from a computing device 108 (e.g., smartphone). Attendance inputs may be initiated by either a call-in or a check-in sequence as partially shown in greater detail in association with screenshots 502, 504 and 506 of FIG. 5. In one embodiment, an app provides a first screenshot from a set of sequential screenshots (graphical guides) to guide an employee to select from or enter specific attendance inputs on user devices 108. For example, a first screenshot 502 may provide the employee a copy of their schedule, check-in screen and a first absence sequence screenshot. However, other screenshots may be used without departing from the scope of the present disclosure. Attendance inputs (e.g., screen selections, typed data or spoken data) may include, but are not limited to, shift selection, date, shift times, attend or not attend (absent), length of absence, reason for absence (e.g., vehicle issue, no ride, sickness, child care, family member issues, pet problems, etc.). In addition, attendance inputs may include obtaining a employee's location as determined from GPS circuitry of the user devices 108.

In step 202, the attendance inputs (204, 206, 208) are communicated over network 106 to the attendance management servers 112 (shown as attendance management 210), mapping servers 102 and stored in DB 104. Attendance management 210 may, in some embodiments, include advancing the screenshots guiding the employee to a next input selection (e.g., to request a rideshare). The process continues in steps 204-208 until the employee's attendance status and needs are fully captured (e.g., will attend, attend with a rideshare, attend with childcare, attend after medical assistance, will not attend, etc.).

In step 204, the system receives an attendance input indicating that the employee will attend their assigned shift on a specific day. While, an employee could enter “attend” for a specific day, they could also indicate the same for a partial day, multiple days, weeks, etc.

In step 206, the system receives an attendance input indicating that the employee will not attend (absent status) their assigned shift on a specific day. As part of this step, the employee can request assistance (“assistance needed”) and be directed to various employee attendance assistance options (see screenshot 506) such as “need ride” and/or “vehicle issue”, “need child care”, “need medical” (illness for self, family member, or pet) of which a specific screenshot that best matches the present employee's needs (e.g., attendance, rideshare, driver input, etc.) will be displayed for input/selection purposes. If the various attendance assistance options are not viable, a “need replacement” process may be implemented to find a suitable replacement (another employee, shift movement, contractor help, etc.)

In step 210, the various attendance assistance inputs are analyzed by the attendance management to first determine best employee attendance assistance options and also to start an automated process for employee attendance reporting (step 212) to a responsible supervisor 214.

Also, in steps 210-214, the captured attendance inputs are uploaded to attendance management processing servers 112 to be instantiated as an attendance model, to include charts, reports, expenses (reporting 212) for a specific department or supervisor (step 214) that is responsible for the employee.

The technology described herein is not limited by the method to produce the attendance model/reports. In one example embodiment, the employee attendance status/needs are uploaded to DB 104 or to another computer/server memory for storage before processing in 102/112. In one example embodiment, the employee attendance status/needs are uploaded to/from third party social media services first before being uploaded to employee attendance status/needs processing servers 102/112 and DB 104. For another example, the inputs are transferred first from a smartphone to a networked computer (e.g., cloud-based server system), and then to attendance management processing servers 112.

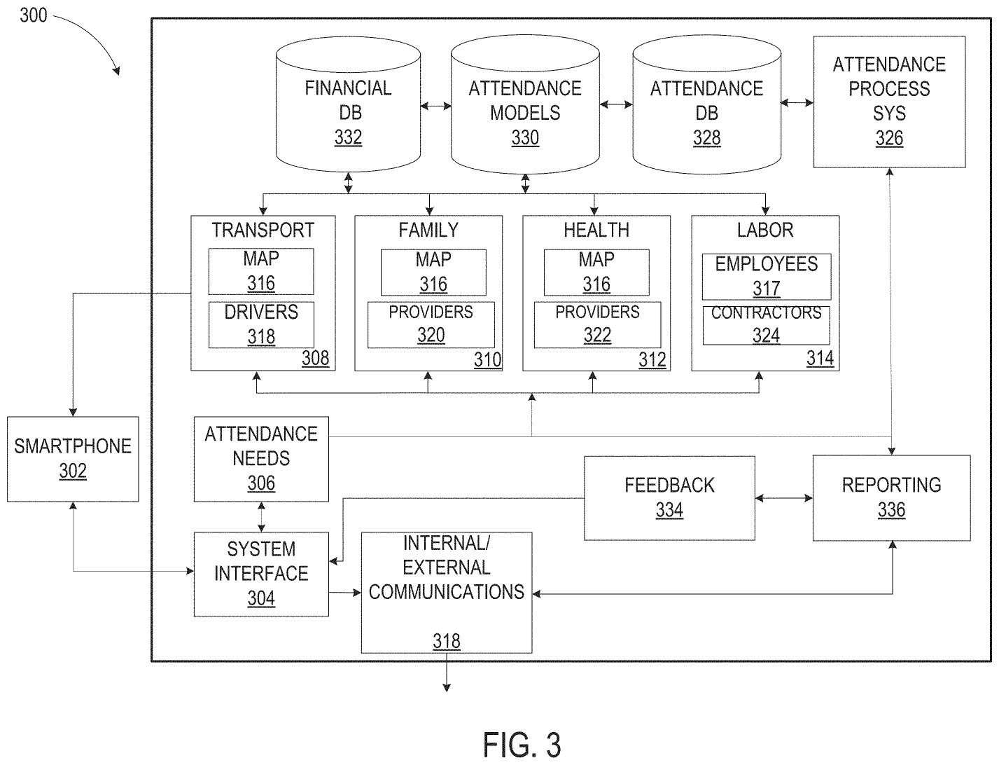

FIG. 3 illustrates one embodiment of a system architecture in accordance with the present disclosure. As shown, attendance management system 300, includes a system interface 304 (e.g., communication adapter, internet connection, wireless circuitry, cellular Rx/Tx circuitry, etc.) allowing user devices 108 (shown as smartphone 302) to communicate with attendance management system 300 to provide employee attendance inputs and receive system responses (e.g., maps). Attendance management system 300 includes one or more computer modules processing computer instructions. Attendance needs module 306 will receive the attendance inputs and determine appropriate attendance assistance option modules (transportation 308 (e.g., rideshare, public transport, etc.), family member assistance 310 (e.g., daycare, senior care, pet care), health 312 (e.g., doctor, clinic, hospital, etc.) or labor 314 (e.g., replacement solutions) as directed by attendance processing/system module 326.

Attendance assistance module “transportation” 308 includes mapping services 316 to provide a visual indication to a smartphone of a position of the smartphone relative to available commuting resources. In addition, it provides bus/train/driver information 318 (name, vehicle information, location, contact information) as well as an ability to obtain and store new driver information (profile, license, insurance, etc.).

Attendance assistance module “Family Assistance” 310 includes mapping services 316 to provide, for example, an assistance solution including a visual indication to a smartphone of a position of the smartphone relative to available daycare resources 320 (providers). In addition, it provides daycare provider information (name, company info, location, contact information) as well as an ability to obtain and store daycare information (profile, license, insurance, etc.). Other family services, such as senior assistance, pet services, etc. are also considered part of family assistance solutions

Attendance assistance module “health” 312 includes mapping services 316 to provide a visual indication of healthcare options including employee position relative to available healthcare resources 322 (providers, such as, hospitals, doctor's offices, clinics, etc.). In addition, it provides healthcare provider information (name, company information, location, contact information) as well as an ability to obtain and store healthcare information (profile, doctors, health insurance accepted, etc.).

Attendance assistance module “labor” 314 includes services to provide labor options including shift options, replacement employees 317 or available contractors 324.

Attendance process and system 326 module (functionality provided by attendance management servers 112) provides analytics and processes instructions to analyze, optimize, track and report 336 the entire attendance process (including providing feedback 334 to the various users of the system through internal/external communications modules 318). Attendance process and system 326 module works in conjunction with attendance database 328 (DB 104) that stores attendance related data, attendance models 330 that optimize the attendance process through attendance models continuously improved by machine learning, artificial intelligence (AI) or deep learning modules (not shown), and financial modules 332 that synthesize attendance related costs, savings, budgets and cost trends.

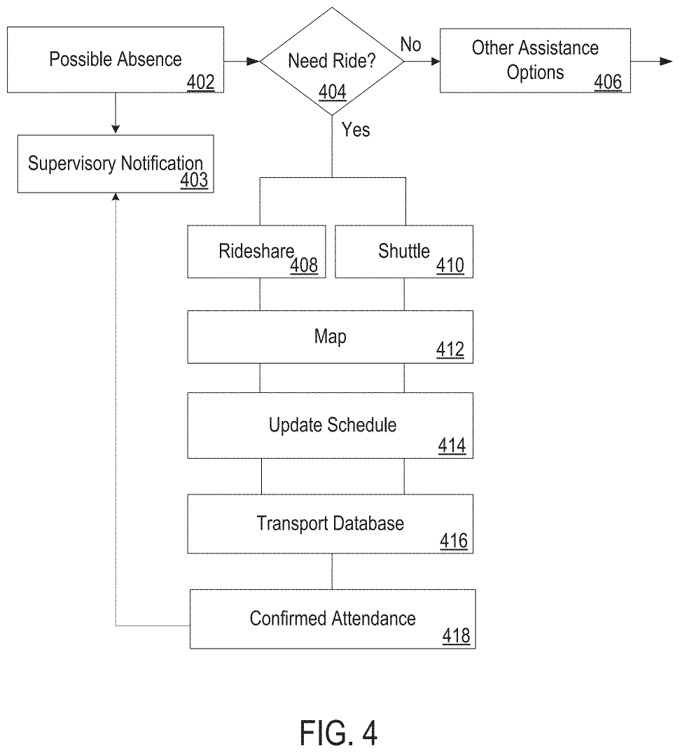

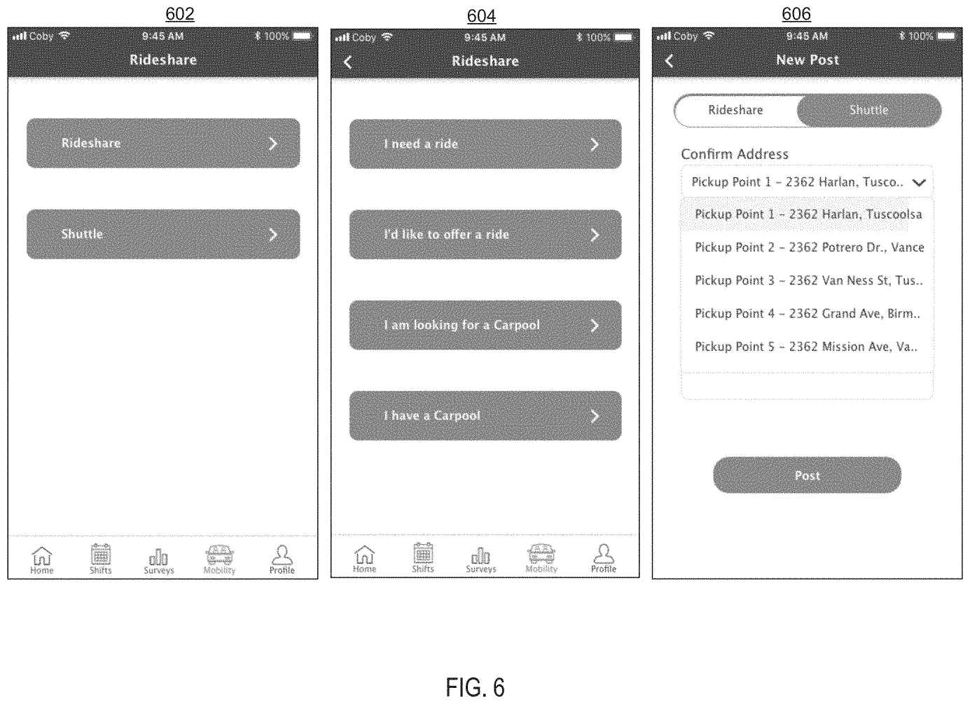

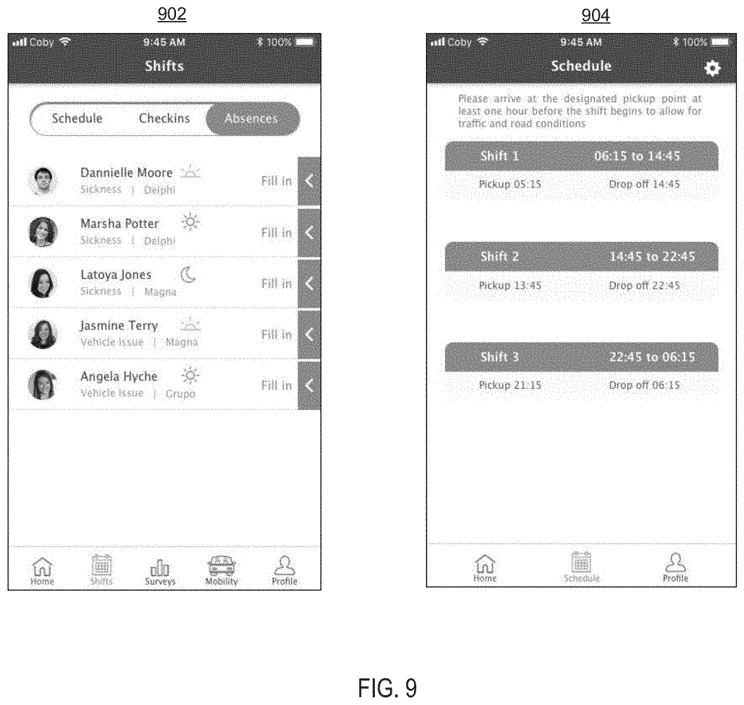

FIG. 4 illustrates a diagram of transforming a possible employee absence into a confirmed attendance through employee transportation options in accordance with the present disclosure. In step 402, a possible absence (attendance input) is received by system 300 and passed, in a supervisory notification step 403, for notification to a responsible supervisor (see FIG. 9, screenshot 902). In an attempt to transform a negative data point into a positive data point, the system 300 solicits various inputs from the employee. In a transportation example (transport module 308), step 404, an employee is asked if they need a ride. If NO, the employee is advanced to other possible attendance assistance options in step 406. If YES, the employee can select from a rideshare solution (or offer a rideshare) 408 with other employees working a similar shift and living in a similar local or a shuttle 410 from a shuttle location map and associated schedule. A mapping module 316 will visualize various map specific options 412 (see FIGS. 6-8, elements 602, 604, 606, 702, 704, 706, 802, 804 and 806). However, the method is not limited by specific screenshots. A schedule will be created 414 (see FIG. 9, screenshot 904). In step 416, the transport information for the various employees using the transport system will be uploaded to attendance DB 328 (DB 106). In step 418, a transformed negative data point (now a confirmed attendance) is passed, to step 403, to reporting module 336 for further notification to a responsible supervisor.

FIG. 5 illustrates an example of screen images for an employee check-in in accordance with the present disclosure. Screenshot 502 illustrates a first graphical guide “Schedule” to receive an employee input selection of morning, afternoon or night shift for an employee working for a company. A second graphical guide, “Check-ins” will allow an employee to confirm attendance. A third guide, “Absences” will initiate an absent status conversion process as described throughout the technology described herein. Screenshot 504 reflects an absent graphical guide to capture a time frame of absence and initiate screenshot 506 for specific reason(s) of an absence. Screenshot 506 reflects an absence graphical guide to capture a specific reason(s) for an absence. Examples include vehicle issue(s), no ride, sickness, childcare, other (e.g., family member issue, pet issue, etc.), etc.

FIG. 6 illustrates an example of screen images for employee assistance transportation options in accordance with the present disclosure. Screenshot 602 reflects a rideshare graphical guide to capture a specific available selection of potential transportation solutions. Examples include a rideshare process, shuttle process, etc. Selecting rideshare will initiate graphical guide 604 that reflects specific rideshare solutions. Examples include need a ride, offer a ride, need a carpool, offering a carpool, etc. Selecting shuttle will initiate graphical guide 606 that reflects specific shuttle solutions (private or public). Examples include a listing of specific pick-up points and a selection thereof. Another example includes integrating a public transit schedule and location (map based) into the shuttle solution.

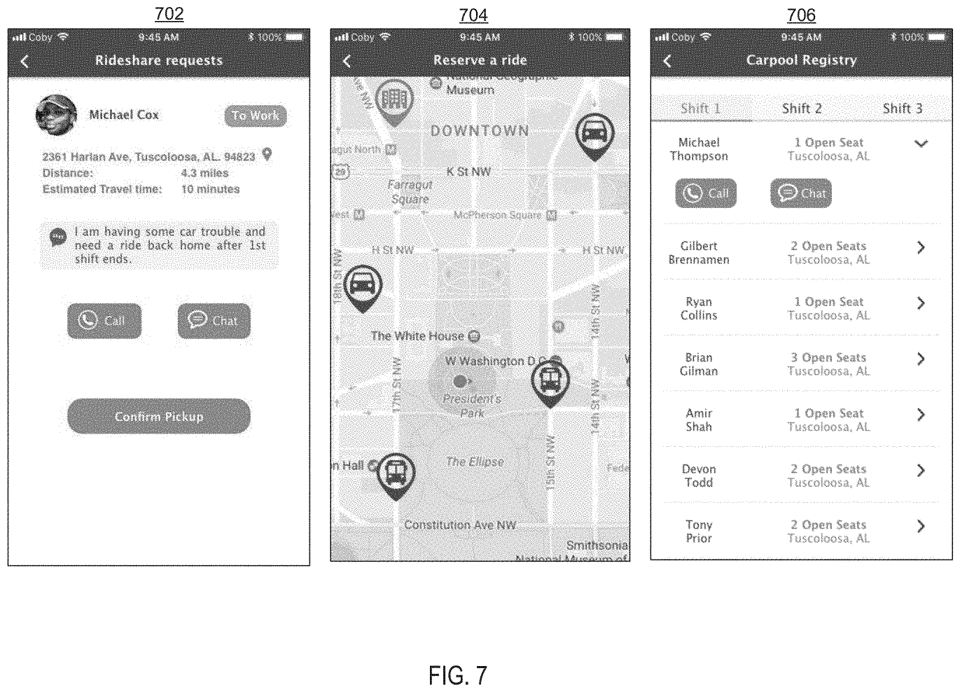

FIG. 7 illustrates an example of screen images for additional employee assistance rideshare options in accordance with the present disclosure. Screenshot 702 reflects a rideshare graphical guide to capture a specific rideshare request including location, reason, contact selections and confirmation of pickup. Screenshot 704 reflects a rideshare graphical map with specific available selections and locations of potential transportation solutions (e.g., vehicle or bus). Screenshot 706 reflects a carpool registry graphical guide to capture specific available carpool transportation solutions for each shift and available employee transport slots for specific drivers/vehicles.

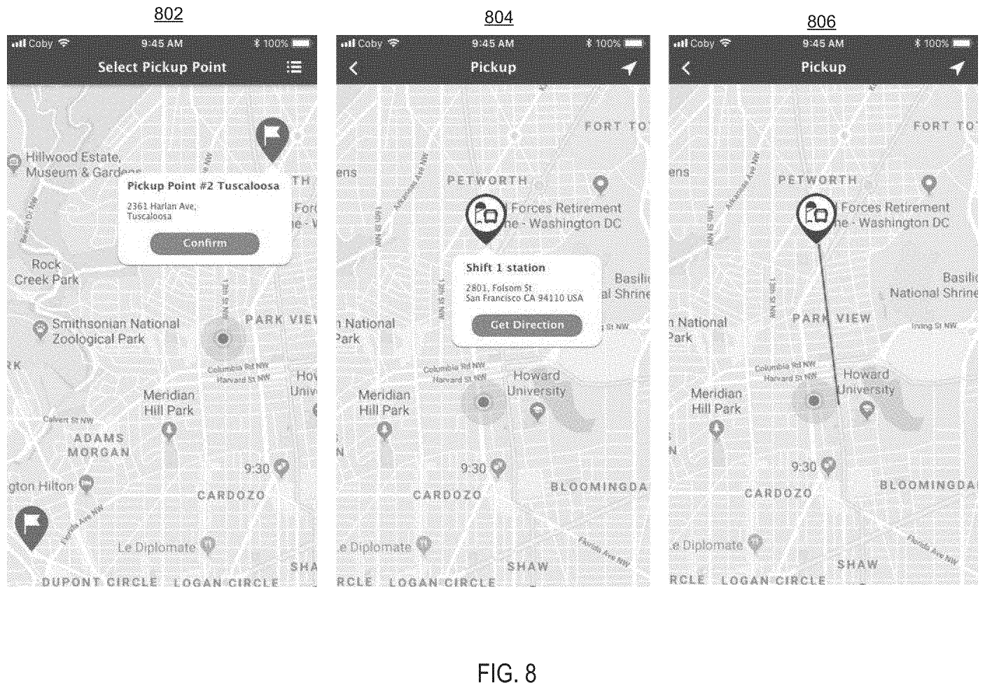

FIG. 8 illustrates an example of screen images for potential pick-up options in accordance with the present disclosure. Screenshot 802 reflects a rideshare graphical guide to capture a specific location to create a potential rideshare transportation solution. As shown, an employee can confirm a specific pick-up point as a rideshare option for others. Screen shot 804 illustrates a map for transportation solutions (e.g., shuttle/bus/train) and routing information (806) to work location.

FIG. 9 illustrates an example of screen images for system reporting in accordance with the present disclosure. Screenshot 902 illustrates a listing of absences for a specific shift available to that shift supervisor. Screenshot 904 illustrates a report of a schedule reflecting converted absences for each shift based on previously described transportation solutions.

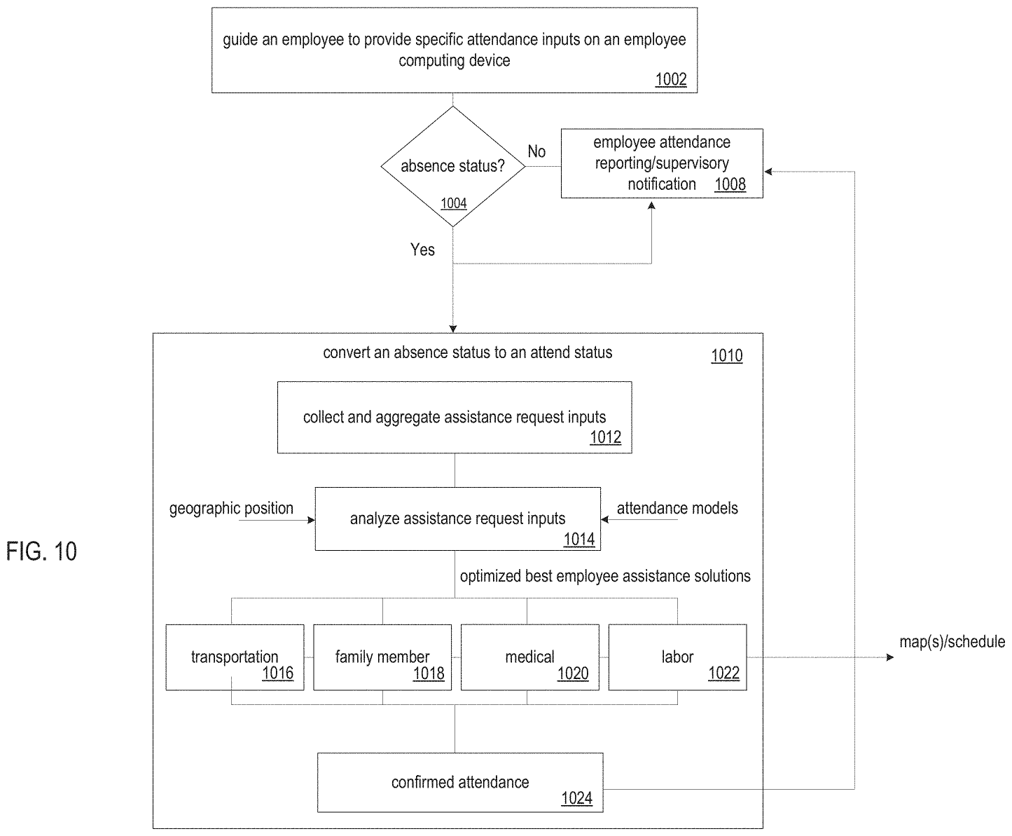

FIG. 10 illustrates a diagram of transforming a possible employee absence into a confirmed attendance through multiple employee assistance options in accordance with the present disclosure. In particular, a method is presented for use in conjunction with one or more functions and features described in conjunction with FIGS. 1-9.

The method begins or continues at step 1002 where a processing module of one or more computing devices of an absentee management system guides an employee to provide (capture) specific attendance inputs (e.g., FIG. 5) on an employee computing device based on a first graphical guides from a set of sequential graphical guides or voice related prompts.

The method continues in step 1004 by determining an employee's work attendance status by receiving and aggregating the specific attendance inputs from a plurality of the employee computing devices to one or more attendance management processing servers, wherein the specific attendance inputs indicate an absence status where the employee(s) will not attend their assigned work time period on a specific day.

The method continues in step 1008 starting an automated process for employee attendance reporting to a responsible supervisor. Various reporting formats may be available from the attendance reporting. For example, for an employee attending work, the supervisor will simply see a shift schedule with attending employees. Those employees whose attendance is in question (absence status) will show, for example, various status indicators, such as absent, absent but in assistance mode, shown with a replacement or shown as an unfilled position.

The method continues in step 1010 by entering into a method to convert an absence status to an attend status where, after selecting attendance assistance solutions, the employee will attend their assigned work time period on a specific day. This method includes step 1012 guiding an employee(s) to provide attendance assistance request inputs on the employee computing devices. The inputs are aggregated for a plurality of employees to ensure a coordinated employee assistance program. This method further includes step 1014 of analyzing a plurality of the attendance assistance request inputs by the attendance management processing servers, the analyzing based on at least on a relative geographical position of the employee computing device to available attendance assistance options to first determine best available employee attendance assistance options. First the system finds a best solution for each employee and then optimizes these best solutions by considering how these potential best solutions might intersect each other. For example, when three employees needing transportation assistance live in close proximity to each other and work on the same shift, the system coordinates an optimized solution offering that includes all three employees riding together. The optimization may include modifying the best solution offered to a specific employee for greater synergy of the overall solution, as it relates to another employee's assistance needs.

This method further includes steps 1016 (transportation assistance), 1018 (family member assistance, e.g., child care, parental senior care, pet assistance (e.g., pet sitter, dog walker, veterinarian, etc.), etc.), medical assistance 1020 (clinic, doctor, in-home nursing, long-term care, hospital, etc.), labor assistance 1022 (need a replacement), or other similar, equivalent or employee needs based assistance programs. The method continues in step 1024, where, based on the attendance assistance request inputs and further on the attendance management processing servers optimization of best attendance assistance solutions, employees are directed to various employee attendance assistance options to include specific solution information including at least graphical mapping of the specific solutions, the specific solutions including any of: transportation assistance, family member assistance, medical assistance or labor assistance until the absence status is converted to an attend status which is fed back to reporting 1008 to update shift attendance reports.

This disclosure contemplates the computer systems taking any suitable physical form. As example and not by way of limitation, computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system may include one or more computer systems; be unitary or distributed; span multiple locations; span multiple machines; or reside in a cloud, which may include one or more cloud components in one or more networks. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

A computer includes a processor that may be, for example, a conventional microprocessor/processor such as an Intel microprocessor/CPU or Motorola PC microprocessor/CPU. One of skill in the relevant art will recognize that the terms “machine-readable (storage) medium” or “computer-readable (storage) medium” include any type of device that is accessible by the processor.

Computer memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Modules may include hardware and/or software. Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, isdn modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted reside in the interface.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

The technology as described herein may have also been described, at least in part, in terms of one or more embodiments. An embodiment of the technology as described herein is used herein to illustrate an aspect thereof, a feature thereof, a concept thereof, and/or an example thereof. A physical embodiment of an apparatus, an article of manufacture, a machine, and/or of a process that embodies the technology described herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the technology as described herein have been expressly described herein, other combinations of these features and functions are likewise possible. For example, the steps may be completed in varied sequences to complete the textured facades. The technology as described herein is not limited by the particular examples disclosed herein and expressly incorporates these other combinations.

The method described above in conjunction with the processing module can alternatively be performed by other modules of the dispersed storage network or by other computing devices. In addition, at least one memory section (e.g., a non-transitory computer readable storage medium) that stores operational instructions can, when executed by one or more processing modules of one or more computing devices of the dispersed storage network (DSN), cause the one or more computing devices to perform any or all of the method steps described above.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “module”, “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations

What is claimed is:

1. A method for execution by one or more processing modules of one or more computing devices of an absentee management system, the method comprises:
guiding an employee to provide specific attendance inputs on an employee computing device based at least on a first guide from a set of sequential guides;
receiving and aggregating the specific attendance inputs from a plurality of the employee computing devices to one or more attendance management processing servers, wherein the specific attendance inputs indicate an absence status where the employee(s) will not attend their assigned work time period on a specific day;
starting an automated process for employee attendance reporting to a responsible supervisor;
converting the absence status to an attend status where the employee(s) will attend their assigned work time period on a specific day by:
guiding an employee to provide attendance assistance request inputs on the employee computing devices based at least on a first guide from a set of sequential guides requesting assistance;
analyzing a plurality of the attendance assistance request inputs by the attendance management processing servers, the analyzing based at least on a relative geographical position of the employee computing device to available attendance assistance options to determine best available employee attendance assistance options; and
based on an optimization of the best available employee attendance assistance options, directing the employee to various employee attendance assistance solutions to include specific solution information including at least graphical mapping of the best available employee attendance assistance solutions, the best available employee attendance assistance solutions including any of: transportation assistance, family member assistance, medical assistance or labor assistance, until the absence status is converted to an attend status.

2. The method of claim 1, wherein the specific attendance inputs are uploaded to attendance management processing servers to be instantiated as an attendance model.

3. The method of claim 1 further comprises providing one or more correlated attendance charts, reports, or expense reporting for a specific department or supervisor that is responsible for the employee.

4. The method of claim 1, wherein the graphical mapping of the best available employee attendance assistance solutions is instantiated as one or more: displayable maps, directions, or schedules.

5. The method of claim 1, wherein the employee computing device includes one or more of: a smartphone, a tablet, a portable computer, a personal computer or wearable computer.

6. The method of claim 1, wherein the specific attendance inputs are initiated by either a call-in or a check-in sequence.

7. The method of claim 1, wherein the set of sequential guides include one or more of: copy of a schedule, check-in screen, or a first absence sequence.

8. The method of claim 1, wherein the specific attendance inputs include any of: screen selections, typed data, or spoken data.

9. The method of claim 1, wherein the specific attendance inputs include any of: shift selection, date, shift times, attend, not attend, length of absence, reason for absence, employee's location.

10. The method of claim 9, wherein the reason for absence includes any of: vehicle issue, no ride, sickness, child care, parental care or pet care.

11. The method of claim 9, wherein the employee's location is determined from GPS circuitry of the employee computing device.

12. The method of claim 1, wherein the converted to an attend status includes a suitable replacement for the employee including any of: a shift movement for the employee, another employee shift movement, a replacement employee, or a contractor.

13. The method of claim 1, wherein the optimization of the best available employee attendance assistance options includes modifying one or more of the best available employee attendance assistance options.

14. A system comprises:
an interface;
a local memory; and
a processing module operably coupled to the interface and the local memory, wherein the processing module functions to:
guide an employee to provide specific attendance inputs on an employee computing device based at least on a first guide from a set of sequential guides;
receive and aggregate the specific attendance inputs from a plurality of the employee computing devices to one or more attendance management processing servers, wherein the specific attendance inputs indicate an absence status where the employee(s) will not attend their assigned work time period on a specific day;
start an automated process for employee attendance reporting to a responsible supervisor;
convert the absence status to an attend status where the employee(s) will attend their assigned work time period on a specific day by:
guiding an employee to provide attendance assistance request inputs on the employee computing devices based at least on a first guide from a set of sequential guides requesting assistance;
analyze a plurality of the attendance assistance request inputs by the attendance management processing servers, the analyzing based at least on a relative geographical position of the employee computing device to available attendance assistance options to determine best available employee attendance assistance options; and
based on an optimization of the best available employee attendance assistance options, direct the employee to various employee attendance assistance solutions to include specific solution information including at least graphical mapping of the best available employee attendance assistance solutions, the best available employee attendance assistance solutions including any of: transportation assistance, family member assistance, medical assistance or labor assistance, until the absence status is converted to an attend status.

15. The system of claim 14, wherein an absence includes one or more reasons including: vehicle issue, no transportation, personal sickness, family sickness, child care or pet care.

16. The system of claim 14, wherein the relative geographical position of the employee computing device is determined from GPS circuitry of the employee computing device.

17. The system of claim 14, wherein the convert the absence status to an attend status includes a suitable replacement for the employee including any of: a shift movement for the employee, another employee shift movement, a replacement employee, or a contractor.

18. An absentee management system comprises:
an application to guide an employee to capture specific attendance inputs on an employee computing device based at least on a first graphical guide from a set of sequential graphical guides;
an interface for receiving from communication networks the specific attendance inputs from the employee computing devices to be stored in an attendance database;
an attendance processing system to process employee attendance needs based on the specific attendance inputs, wherein the specific attendance inputs indicate an absence status where the employee will not attend their assigned work time period on a specific day;
a reporting module to start an automated process for employee attendance reporting to a responsible supervisor;
an attendance model server receiving the employee attendance needs and collectively analyzing a plurality of the employee attendance needs using an employee attendance model;
a mapping module to determine a location of the employee and to provide mapped best geographic solutions to an attendance model system to guide an employee to capture attendance assistance request inputs on the employee computing devices based at least on a first graphical guide from a set of sequential graphical guides request assistance; and
wherein the attendance processing system converts the absence status to an attend status where the employee will attend their assigned work time period on a specific day by:
analyzing the attendance assistance request inputs, the analyzing based at least on a relative geographical position of the employee computing device to available attendance assistance options to first determine best available employee attendance assistance options; and
based on an optimization of the best available employee attendance assistance options, directing the employee to various employee attendance assistance solutions to include specific solution information including at least graphical mapping of the best available employee attendance assistance solutions, the best available employee attendance assistance solutions including any of: transportation assistance, family member assistance, medical assistance or labor assistance, until the absence status is converted to an attend status.

19. The absentee management system of claim 18, wherein the optimization of the best available employee attendance assistance options includes modifying one or more of the best available employee attendance assistance options.

20. The absentee management system of claim 18, wherein the absence status is converted to an attend status includes a suitable replacement for the employee including any of: a shift movement for the employee, another employee shift movement, a replacement employee, or a contractor.
